(19) United States
(12) Patent Application Publication
(10) Pub. No.: US 2024/0267166 A1
(43) Pub. Date: Aug. 8, 2024

(54) ENHANCED SPECTRAL SHAPING FOR CELLULAR COMMUNICATION NETWORKS

(71) Applicant: Nokia Technologies Oy, Espoo (FI)

(72) Inventors: Kari Pekka PAJUKOSKI, Oulu (FI); Esa Tapani TIIROLA, Oulu (FI); Arto LEHTI, Massy (FR); Ismael PERUGA NASARRE, Oulu (FI)

(21) Appl. No.: 18/294,417

(22) PCT Filed: Aug. 6, 2021
(86) PCT No.: PCT/EP2021/072004

§ 371 Date: Feb. 1, 2024

(51) Int. Cl. H04L 5/00; H04L 25/03

(52) U.S. Cl. CPC H04L 5/0005; H04L 25/03834

(57) ABSTRACT

According to an example aspect of the present invention, there is provided a method, comprising, receiving, by a user equipment, a resource allocation from a wireless network node, for transmission of at least one signal, wherein the resource allocation comprises at least a frequency domain resource allocation, determining, by the user equipment, at least one spectrum flatness requirement based at least on the frequency domain resource allocation and transmitting, by the user equipment, the at least one signal to the wireless network node according to the at least one spectrum flatness requirement.

### FIELD

Various example embodiments relate in general to cellular communication networks and more specifically, to spectral shaping in such networks.

### BACKGROUND

Higher Peak-to-Average Power Ratio, PAPR, may occur for example in multicarrier communication systems, wherein different sub-carriers may be out of phase compared to each other, thereby causing a peak in an output envelope. Spectral shaping may be used to achieve lower PAPR and hence, enable lower maximum power reduction and higher transmission power. Reduction of PAPR is important for various cellular networks, such as, networks operating according to Long Term Evolution, LTE, and/or 5G radio access technology. 5G radio access technology may also be referred to as New Radio, NR, access technology. 3rd Generation Partnership Project, 3GPP, still develops LTE and also standards for 5G/NR. According to the discussions there is a need to provide enhanced methods, apparatuses and computer programs related to spectral shaping in cellular communication networks.

### SUMMARY

According to some aspects, there is provided the subject-matter of the independent claims. Some embodiments are defined in the dependent claims.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided a method comprising, receiving, by a user equipment, a resource allocation from a wireless network node, for transmission of at least one signal, wherein the resource allocation comprises at least a frequency domain resource allocation, determining, by the user equipment, at least one spectrum flatness requirement based at least on the frequency domain resource allocation and transmitting, by the user equipment, the at least one signal to the wireless network node according to the at least one spectrum flatness requirement.

Embodiments of the first aspect may comprise at least one feature from the following bulleted list:
determining, by the user equipment, the at least one spectrum flatness requirement based at least on a size of the frequency domain resource allocation. In some embodiments, the size of the frequency domain resource allocation is a number of physical resource blocks;
determining, by the user equipment, the at least one spectrum flatness requirement based at least on a location of the frequency domain resource allocation in frequency within a channel bandwidth and/or transmission bandwidth. In some embodiments, said determining the at least one spectrum flatness requirement based at least on the location of the frequency domain resource allocation comprises determining whether the frequency domain resource allocation is on a central part or an edge part of the channel bandwidth and/or transmission bandwidth;
the at least one spectrum flatness requirement comprises a maximum allowed ripple. In some embodiments, the maximum allowed ripple is smaller for frequency domain allocations below a threshold and larger for frequency domain allocations above the threshold. In some embodiments, the maximum allowed ripple is smaller for center allocations compared to edge allocations. In some embodiments, the maximum allowed ripple is calculated as follows:

$${R}_{n} = {k}_{n} * N + {C}_{n} ,$$

wherein R_n is the maximum allowed ripple, k_n is a constant for a frequency band, N is a number of allocated physical resource blocks and C_n is another constant for the frequency band. In some embodiments, the maximum allowed ripple is defined separately for edge resource allocations, outer resource allocations and inner resource allocations.
transmitting, by the user equipment, capability information on the user equipment to the wireless network node, wherein said capability information comprises an indication indicating that the user equipment supports frequency domain resource allocation-based spectrum flatness requirements. In some embodiments, the indication indicates that the user equipment supports frequency domain resource allocation-based spectrum flatness requirements for at least one modulation scheme. In some embodiments, the at least one modulation scheme comprises π/2 binary phase shift keying;
receiving, by the user equipment, a configuration signal from the wireless network node, the configuration signal configuring the user equipment to switch adaptive spectrum flatness configuration on and switching, by the user equipment, the adaptive spectrum flatness configuration on to transmit the at least one signal according to the at least one spectrum flatness requirement;
determining, by the user equipment, a transmit filter for transmitting the at least one signal according to the at least one adaptive spectrum flatness requirement and transmitting, by the user equipment, the at least one signal using the transmit filter;
determining whether the at least one spectrum flatness requirement applies to one or more than one frequency band of the resource allocation;
determining a frequency band of the resource allocation from at least two frequency bands and determining the at least one spectrum flatness requirement based on the determined frequency band;
determining a border between a first and a second frequency band based on the resource allocation and applying the at least one spectrum flatness requirement for resource allocations above the border.

According to a second aspect, there is provided a method comprising, transmitting, by a wireless network node, a resource allocation to a user equipment for transmission of at least one signal, determining, based on capability information on the user equipment and the resource allocation, at least one spectrum flatness requirement regarding transmission of the at least one signal and receiving the at least one signal according to the at least one spectrum flatness requirement.

Embodiments of the second aspect may comprise at least one feature from the following bulleted list:
receiving, by the wireless network node, capability information on the user equipment from the user equipment, wherein said capability information comprises an indication indicating that the user equipment supports frequency domain resource allocation-based spectrum flatness requirements;
transmitting, by the wireless network node, a configuration signal to the user equipment, the configuration signal configuring the user equipment to switch adaptive spectrum flatness configuration on.

According to a third aspect of the present invention, there is provided an apparatus, such as a user equipment or a control device configured to control the user equipment, comprising at least one processing core, at least one memory including computer program code, the at least one memory and the computer program code being configured to, with the at least one processing core, cause the apparatus at least to perform, receive a resource allocation from a wireless network node, for transmission of at least one signal, wherein the resource allocation comprises at least a frequency domain resource allocation, determine at least one spectrum flatness requirement based at least on the frequency domain resource allocation and transmit the at least one signal to the wireless network node according to the at least one spectrum flatness requirement. The at least one memory and the computer program code, with the at least one processing core, may further cause the apparatus at least to perform the method of the first aspect.

According to a fourth aspect of the present invention, there is provided an apparatus, such as a wireless network node or a control device configured to control the user equipment, comprising at least one processing core, at least one memory including computer program code, the at least one memory and the computer program code being configured to, with the at least one processing core, cause the apparatus at least to perform, transmit a resource allocation to a user equipment for transmission of at least one signal, determine, based on capability information on the user equipment and the resource allocation, at least one spectrum flatness requirement regarding transmission of the at least one signal and receive the at least one signal according to the at least one spectrum flatness requirement. The at least one memory and the computer program code, with the at least one processing core, may further cause the apparatus at least to perform the method of the second aspect.

According to a fifth aspect of the present invention, there is provided an apparatus, such as a user equipment or a control device configured to control the user equipment, comprising means for receiving a resource allocation from a wireless network node, for transmission of at least one signal, wherein the resource allocation comprises at least a frequency domain resource allocation, means for determining at least one spectrum flatness requirement based at least on the frequency domain resource allocation and means for transmitting the at least one signal to the wireless network node according to the at least one spectrum flatness requirement. The apparatus may further comprise means for performing the method of the first aspect.

According to a sixth aspect of the present invention, there is provided an apparatus, such as a wireless network node or a control device configured to control the user equipment, comprising means for transmitting a resource allocation to a user equipment for transmission of at least one signal, means for determining, based on capability information on the user equipment and the resource allocation, at least one spectrum flatness requirement regarding transmission of the at least one signal and means for receiving the at least one signal according to the at least one spectrum flatness requirement. The apparatus may further comprise means for performing the method of the second aspect.

According to a seventh aspect of the present invention, there is provided non-transitory computer readable medium having stored thereon a set of computer readable instructions that, when executed by at least one processor, cause an apparatus to at least perform the method of the first or the second aspect. According to an eighth aspect of the present invention, there is provided a computer program comprising instructions which, when the program is executed by an apparatus, cause the apparatus to carry out the method of the first or the second aspect.

### BRIEF DESCRIPTION OF THE DRAWINGS

FIG. 1 illustrates an example of a network scenario in accordance with at least some embodiments;

FIG. 2 illustrates an example of a bandwidth edge condition in accordance with at least some embodiments;

FIG. 3 illustrates a signaling graph in accordance with at least some embodiments;

FIG. 4 illustrates an example apparatus capable of supporting at least some embodiments; and

FIG. 5 illustrates a flow graph of a first method in accordance with at least some embodiments;

FIG. 6 illustrates a flow graph of a second method in accordance with at least some embodiments;

FIG. 7 illustrates a PUSCH with 8 PRBs in accordance with at least some embodiments.

### EMBODIMENTS

Spectral shaping may be enhanced in cellular communication networks by the procedures described herein. In general, at least in cellular communication networks Frequency Domain Spectral Shaping, FDSS, may be used at least for uplink transmissions but there may be requirements for spectral flatness and the detection loss may be significant for small resource allocation due to FDSS. Embodiments of the present invention therefore make it possible to associate spectrum flatness requirements with the allocated resources. For instance, the spectrum flatness requirements may depend on the allocated resources such that a maximum allowed ripple may be smaller for smaller resource allocations, to guarantee good system performance in case of small resource allocations.

According to embodiments of the present invention, various Frequency Domain Resource Allocation, FDRA, schemes may be applied, such as a resource allocation indicating a starting Physical Resource Block, PRB, and the ending PRB in frequency domain. That is, a resource allocation may refer to a FDRA. Moreover, even though PRB allocations are used as an example, embodiments of the present invention may be applied for any resource allocation in frequency domain in general. In some embodiments, the resource allocation may also comprise a time domain resource allocation.

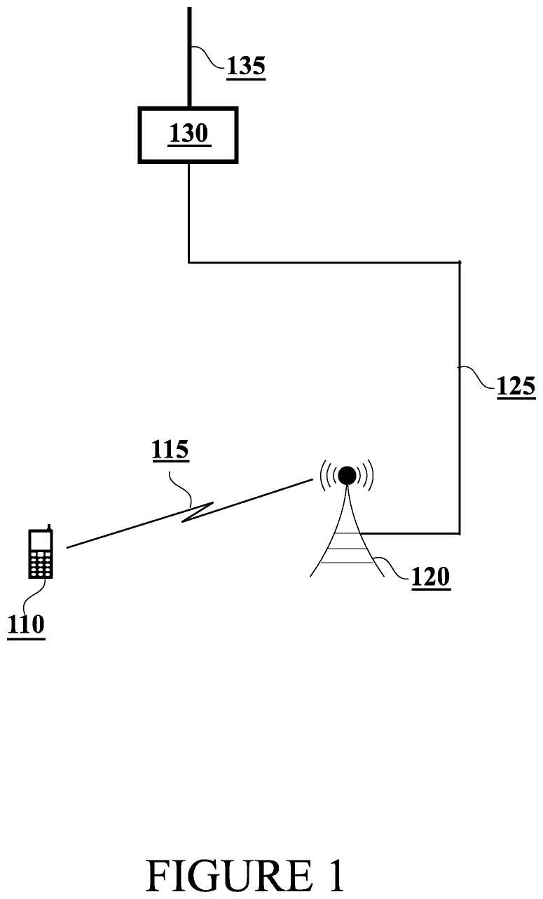

FIG. 1 illustrates an example of a network scenario in accordance with at least some example embodiments. According to the example scenario of FIG. 1, there may be a cellular communication network comprising one or more User Equipments, UEs, 110, at least one Base Station, BS, 120, and core network element 130. In the example network of FIG. 1, UE 110 may communicate wirelessly with BS 120, or with a cell of BS 120, via air interface 115. In some example embodiments, BS 120 may be considered as a serving Base Station, BS, for UE 110. Even though BS 120 is used as an example, any wireless network node in general may perform tasks of BS 120. Alternatively, or in addition, UE 110 may be connected directly to another UE via air interface 115 or some other suitable air interface, e.g., for performing direct Device-to-Device, D2D, communications. Embodiments of the present invention may be applied for satellite communications in the context of Non-Terrestrial Networks, NTNs, as well.

UE 110 may comprise, for example, a smartphone, a cellular phone, a Machine-to-Machine, M2M, node, Machine-Type Communications node, MTC, an Internet of Things, IoT, node, a D2D node, a car telemetry unit, a laptop computer, a tablet computer or, indeed, any kind of suitable wireless terminal, station, or a relay.

Air interface 115 may be configured in accordance with a Radio Access Technology, RAT, which UE 110 and BS 120 are configured to support. Examples of cellular RATs include Long Term Evolution, LTE, New Radio, NR, which may also be known as fifth generation, 5G, radio access technology and MulteFire. For example, in the context of LTE, BS 120 may be referred to as eNB while BS 120 may be referred to as gNB in the context of NR. In any case, example embodiments are not restricted to any particular wireless technology. Instead, example embodiments may be exploited in any cellular communication network wherein spectral shaping is used.

BS 120 may be connected, directly or via at least one intermediate node, with core network 130 via interface 125. Core network 130 may be, in turn, coupled via interface 135 with another network (not shown in FIG. 1), via which connectivity to further networks may be obtained, for example via a worldwide interconnection network. BS 120 may be connected with at least one other BS as well via an inter-base station interface (not shown in FIG. 1), even though in some example embodiments the inter-base station interface may be absent. BS 120 may be connected, directly or via at least one intermediate node, with core network 130 or with another core network.

In some embodiments, the network scenario may comprise a relay node instead of, or in addition to, UE 110 and/or BS 120. Relaying may be used for example when operating on millimeter-wave frequencies. One example of the relay node may be an Integrated Access and Backhaul, IAB, node. The IAB node may be referred to as a self-backhauling relay as well. Another example of a relay may be an out-band relay. In general, the relay node may comprise two parts:
1) Distributed Unit, DU, part which may facilitate functionalities of BS 120, such as a gNB. Thus, in some example embodiments, the DU part of a relay may be referred to as BS 120 and the DU may perform tasks of BS 120;
2) Mobile Termination, MT, part which may facilitate functionalities of UE 110, i.e., a backhaul link which may be the communication link between a parent node (DU), such as a DU part of BS 120, and the relay, such as an IAB node. In some example embodiments, the MT part may be referred to as UE 110 and perform tasks of UE 110.

Spectral shaping may be used to achieve lower Peak-to-Average Power Ratio, PAPR, and Cubic Metric, CM, to lower maximum power reduction and higher transmission power. CM may refer to a metric for the reduction in power capability of a typical power amplifier, e.g., in a mobile handset. FDSS is one of techniques which may be used to achieve high spectral efficiency for narrowband and high bandwidth applications/scenarios. Embodiments of the present invention may be particularly useful in case of narrowband scenarios. An FDSS function may be applied to data converted into frequency domain. After applying the FDSS function, data may be mapped to frequency domain resource elements and converted into time domain.

For instance, 3rd Generation Partnership Project, 3GPP, NR Rel-15 supports FDSS for π/2 Binary Phase Shift Keying, BPSK, and FDSS may be applied to uplink transmission with π/2 BPSK. There may be requirements for spectral flatness though. Use of spectral shaping is supposed to be transparent for receiver, which may be achieved by using the same shaping filter for both Demodulation Reference Signal, DMRS, and Physical Uplink Shared Channel, PUSCH, data. Spectral flatness requirements may be used to ensure transparency to receiver, i.e., to facilitate FDSS without specifying the actual filter shape for UE 110.

Objectives for optimization of power of uplink transmissions with π/2 BPSK may comprise at least identifying shaping filter characteristics necessary to enable the new power capability while ensuring good and robust BS receiver performance. Moreover, specification of a pulse shaping filter may need to be justified for a new identified UE power capability if it differs from filter impulse response specification in 3GPP TS 38.101-1 clause 6.4.2.4.1. E and it may need to be identified if necessary changes are needed to Error Vector Magnitude, EVM, equalizer flatness mask requirements to capture necessary filter shaping. Changes to the existing 14 dB peak-to-peak baseline to be assessed in relation to any potential gains in UL link performance while still ensuring robust BS receiver performance for all UEs in a cell. Thus, one of the objectives is to specify transmitter FDSS filter shapes and evaluate if changes are needed to the EVM equalizer flatness mask requirements.

The EVM equalizer flatness may be used for setting the UE Tx spectral flatness requirements for π/2-BPSK with spectral shaping. The peak-to-peak variation of the EVM equalizer coefficients may be contained within the frequency band of the uplink allocation and it may not be allowed to exceed the limits defined, e.g., in the 3GPP specifications. The spectral flatness requirement when spectral shaping is used for π/2-BPSK (without spectral extension) may be defined for two frequency bands that divide the allocation in two equal-size parts. That is, there may be a first, lower frequency band and subsequent to that in frequency a second, higher frequency band and first and the second band may have different spectral flatness requirements. The first and second frequency bands may be frequency bands of the same resource allocation, such as a PRB allocation.

The FDSS filter used may be a filter that still meets current spectral flatness requirement. However, the detection loss due to the use of FDSS may be quite significant for small resource allocations, such as small Physical Resource Block, PRB, allocations compared to the case without FDSS, for example if a shape of the filter is too aggressive. The loss may decrease as a size of the resource allocation in frequency increases but be high in extremely small allocations. For instance, if a size of the resource allocation is above 32 or 64 PRBs, the loss may remain relatively constant and at low level. The effect of the FDSS that may generate loss in the receiver (i.e., higher SNR would be needed to achieve same bit-error-rate), may be larger or similar to the generated gain in the transmitter (the device can transmit with higher power with respect to the case without FDSS). The gain, e.g., for the Rel-15 NR approach, may be close to zero, or even negative in extreme cases with very small resource allocation, compared to the case without FDSS. This may be a challenge if the exact FDSS function is not defined, but left for UE implementation. In particular, small allocations may be of interest in certain coverage scenarios. For instance, small allocations may maximize coverage for small data rates while minimizing the amount of PRBs consumed. In a power limited case, increasing the number of PRBs would not improve the coverage since noise bandwidth would be increased as well.

Hence, the challenge addressed by the embodiments of the present invention is that a scenario with small resource allocation may be seen as attractive justification for specifying the exact UE transmit filter which may not be good choice, e.g., for the 3GPP ecosystem. Embodiments of the present invention therefore guarantee good system performance in case of small resource allocations that may suffer due to receiver loss caused by very aggressive filter attenuations on the allocation edges. That is, embodiments of the present invention guarantee good system performance for resource allocations which may have various sizes and thus, good system performance is provided for various applications as well.

According to the embodiments of the present invention, at least one spectrum flatness requirement may be made dependent on resource allocated for transmission of at least one signal. For instance, the at least one spectrum flatness requirement may depend on a size of the resource allocation, such as a number of PRBs and/or a location of the resource allocation, such as a location of PRBs in frequency within the channel bandwidth (and/or transmission bandwidth).

The at least one spectrum flatness requirement may comprise a maximum allowed ripple and the maximum allowed ripple may be determined implicitly based on the resource allocation. For instance, the maximum ripple may be defined such that it is smaller for small PRB allocations, possibly depending on the location of the PRB allocation, and remains constant, i.e., larger, for large PRB allocations, possibly regardless of the location of the PRB allocation. In case of small PRB allocations, the maximum ripple may be smaller if the PRB allocation is on a center part and larger if the PRB allocation is on an edge part of a channel Bandwidth, BW, and/or transmission BW. A motivation behind the arrangement is to optimize the Tx/Rx operation according to the limiting factor, because for small allocations, receiver of BS 120 may be the bottleneck but for edge PRB allocations, transmitter of UE 110 (Output Backoff, OBO, and/or Maximum Power Reduction, MPR) may be the bottleneck.

In some embodiments, the maximum allowed ripple may be calculated explicitly, i.e., the maximum allowed ripple may be directly proportional to the PRB allocation or otherwise calculated based on the PRB allocation. For instance, the maximum allowed ripple may be calculated using the following equation:

$${R}_{n} = {k}_{n} * N + {C}_{n} , \qquad ( 1 )$$

wherein Rₙ is the maximum allowed ripple, kₙ is a constant for a band, N is the number of allocated PRBs and Cₙ is another constant for the band.

In one embodiments, the PRB size/location-based maximum ripple may modify only maximum ripple in a higher, second frequency band, while in another embodiment, the PRB size/location-based maximum ripple may modify also maximum Ripple in a lower, first frequency band. That is, UE 110 may determine whether the at least one spectrum flatness requirement applies to one or more than one frequency band.

In some embodiments, a border between the first and second frequency band may also be determined implicitly based on the PRB allocation and the border may be used, e.g., to set the maximum ripple only to the second frequency band. UE 110 may determine a border between the first and a second frequency band based on the resource allocation and apply the at least one spectrum flatness requirement for resource allocations above the border.

In some embodiments, the maximum allowed ripple may be separately specified for edge PRB allocations, outer PRB allocations and inner PRB allocations, defined for example according to 3GPP TS 38.101.

In some embodiments, the at least one spectral flatness requirement may be divided in more than two frequency bands to account for spectral extension (i.e., redundant copies of the inband that can be used to further reduce the PAPR). That is, in some embodiments, UE 110 may determine a frequency band of the resource allocation from at least two frequency bands and determine the at least one spectrum flatness requirement based on the frequency band, i.e., use the at least one spectrum flatness requirement corresponding to the determined frequency band.

In some embodiments, two or more quantization values may be defined for the maximum allowed ripple, e.g., for the second frequency band. Each of quantization values may apply for different PRB ranges, possibly being also conditioned by the PRB location, and possible spectral extension.

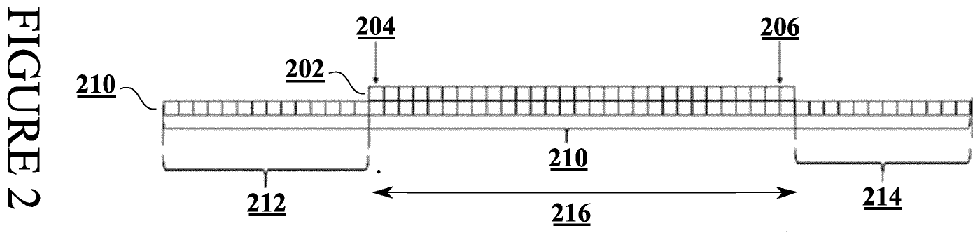

FIG. 2 illustrates an example of a bandwidth edge condition in accordance with at least some embodiments. In FIG. 2, the transmission BW (PRBs) of UE 110 is denoted by 202 and outermost PRBs (low) are denoted by 204 while outermost PRBs (high) are denoted by 206. The transmission BW configuration (PRBs) is denoted by 210 while lower edge part (PRBs) is denoted by 212 and higher edge part (PRBs) is denoted by 214. The central part of transmission BW configuration 210, in between lower edge part 212 and higher edge part 214, is denoted by 216.

In some embodiments, the maximum allowed ripple for small PRB allocations may depend on the location of PRBs in frequency, i.e., whether the allocated resources are on edge parts of BW 212, 214 or central part of BW 216. The condition about whether a resource allocation is considered to be on edge parts of BW 212, 214 or central part of BW 216 may be determined according to various rules. For instance, a resource allocation may be determined to be on a central part of BW if a gap between lower edge part 212, and/or higher edge part 214, and an edge of transmission BW configuration 210 is higher than B1%, or higher than C1 MHz, of a channel BW, wherein the channel BW comprises transmission BW configuration 210 and additional guard bands on the sides of transmission BW configuration 210.

Alternatively, a resource allocation may be determined to be on a central part of BW if outermost PRBs (low) 204 and/or outermost PRBs (high) 206 are not within B1%, or within C1 MHz, of an edge of the channel BW. In some embodiments, B1% may be a proportion of the channel BW.

Alternatively, a resource allocation may be determined to be on a central part of BW if outermost PRBs (low) 204 and/or outermost PRBs (high) 206 are not within B2%, or within C2 MHZ, of an edge of transmission BW configuration 210.

Alternatively, a resource allocation may be determined to be on a central part of BW if a gap between lower edge part 212, and/or higher edge part 214, and an edge of transmission BW configuration 210 is more than or equal to B2%, or more than or equal to C2 MHZ, of transmission BW configuration 210. In some embodiments, B2% may be a proportion of transmission BW configuration 210. B2% may be 15% for example. B1, B2, C1 and/or C2 maybe defined by the specifications, such as 3GPP specifications, or configured by the network, using Radio Resource Control, RRC, signalling for example. In an example, a resource allocation may be determined to be on an edge part of BW if a gap between lower edge part 212, and/or higher edge part 214, and an edge of transmission BW configuration 210 is less than B2%, or less than C2 MHZ, of transmission BW configuration 210.

In addition, or alternatively, a relationship between a granularity and location of the resource allocation to the maximum allowed ripple may be defined in the specification. For instance, the maximum allowed ripple may be defined as 6 dB for the first frequency band and 10 dB for the second frequency band, wherein the second frequency band is higher than the first frequency band.

In some embodiments, the maximum allowed ripple value for larger PRB allocations may be always constant, e.g., when the number of PRBs is at least 32. Edge PRB allocation, such as an allocation on edge part 212 may allow higher ripple values than inner PRB allocations, e.g., on central part 216, for smaller PRB allocations.

In some embodiments, the following rules may be applied for the maximum ripple. Tables 1 and 2 illustrate an example values for maximum allowed ripple for two frequency bands but it should be noted that more frequency bands may be included to account for a possible spectral extension. In tables 1 and 2, Y is the threshold, i.e., a size of the PRB allocation used to determine the maximum allowed ripple, and there are three quantization levels for the allocated PRBs. In this example, a specified maximum ripple may be used for BW edge but different values may also be used.

TABLE 1
Maximum ripple (dB) for a first frequency band

| | Maximum ripple (dB) | Maximum ripple (dB) |
|---|---|---|
| Threshold Y (PRBs) | BW centre | BW edge |
| Y ≤ 5 | 2 | 6 |
| 5 < Y < 32 | 4 | 6 |
| Y ≥ 32 | 6 | 6 |

TABLE 2
Maximum ripple (dB) for a second frequency band

| | Maximum ripple (dB) | Maximum ripple (dB) |
|---|---|---|
| Threshold Y (PRBs) | BW centre | BW edge |
| Y ≤ 5 | 6 | 14 |
| 5 < Y < 32 | 10 | 14 |
| Y ≥ 32 | 14 | 14 |

That is, in some embodiments, rules may be applied for the PRB location within the channel BW. The PRB locations may be quantified into two scenarios for example, as shown in tables 1 and 2. At the central part of the BW, smaller maximum ripple may be allowed when a certain allocation size condition, i.e., threshold Y, is fulfilled compared to the edge part of the BW, as shown in tables 1 and 2.

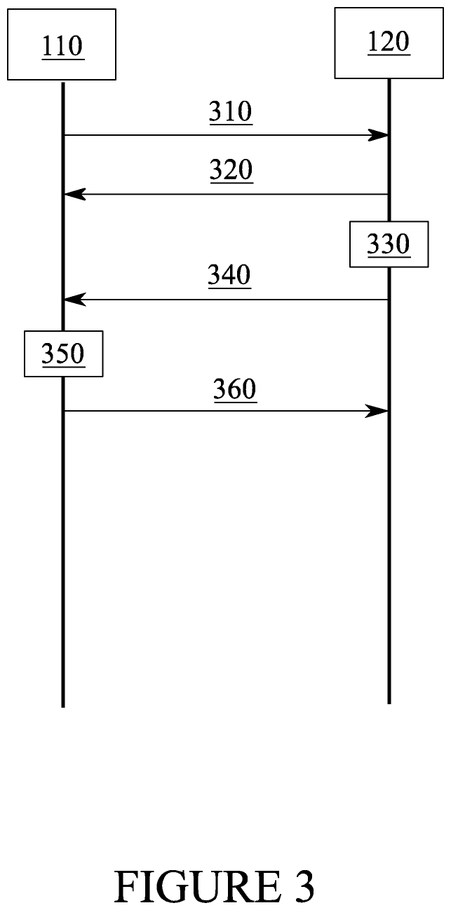

FIG. 3 illustrates a signaling graph in accordance with at least some example embodiments. With reference to FIG. 1, on the vertical axes are disposed, from the left to the right, UE 110 and BS 120. Time advances from the top towards the bottom. Even though communication between UE 110 and BS 120 is used as an example in FIG. 3, embodiments of the present invention may be applied similarly for D2D communication. That is, an uplink grant may be replaced with any resource allocation, such as a sidelink grant, and any signal may be transmitted instead of the uplink signal accordingly.

At step 310, UE 110 may transmit its capability information to BS 120, wherein said capability information may comprise an indication indicating that UE 110 supports FDRA-based spectrum flatness requirements. That is, the indication may indicate that BS 120 may configure UE 110 to transmit uplink signals according to at least one spectrum flatness requirement. In some embodiments, the indication may indicate that UE 110 supports FDRA-based spectrum flatness requirements for at least one modulation scheme, such as π/2 BPSK.

Upon receiving said capability information, BS 120 may transmit, at step 320, a configuration signal to UE 110, to configure UE 110 to switch adaptive spectrum flatness configuration on. Responsive to receiving the configuration signal, UE 110 may switch the adaptive spectrum flatness configuration on to transmit the at least one uplink signal according to at least one spectrum flatness requirement. In an example embodiment, UE 110 does not utilize the adaptive spectrum flatness configuration without receiving the configuration signal from BS 120. In an example embodiment, BS 120 may transmit a configuration signal that switches the adaptive spectrum flatness configuration off.

At step 330, BS 120 may determine a resource allocation for an uplink grant of UE 110. At step 340, BS 120 may transmit the uplink grant to UE 110, wherein the uplink grant may be configured to be used, or usable, by UE 110 to determine at least one spectrum flatness requirement based at least on the resource allocation indicated in the uplink grant.

UE 110 may then, at step 350, determine at least one spectrum flatness requirement based at least on the resource allocation indicated in the uplink grant. For instance, UE 110 may determine the at least one spectrum flatness requirement based at least on a size of the resource allocation, wherein the size of the allocation may be a number of PRBs and/or a location. Alternatively, or in addition, UE 110 may determine the at least one spectrum flatness requirement based at least on a location of the resource allocation in frequency within a channel BW and/or transmission BW.

In some embodiments, BS 120 may determine, based on the capability information on, or of, UE 110 and the resource allocation, i.e., the uplink grant, at least one spectrum flatness requirement regarding transmission of at least one uplink signal. Said determination may be based on the received capability information on, or of, UE 110. Alternatively, the capability information may be pre-configured so that it may be always assumed that UE 110 supports spectrum flatness requirements and determines the spectrum flatness requirement according to the resource allocation. That is, in some embodiments, step 310 and reception of the capability information may be optional.

At step 360, UE 110 may transmit at least one uplink signal according to the at least one spectrum flatness requirement. In some embodiments, UE 110 may also determine a transmit filter for transmitting the at least one uplink signal according to the at least one adaptive spectrum flatness requirement and transmit the at least one uplink signal using the transmit filter.

Embodiments of the present invention therefore enable preventing the loss in link-level performance for small resource allocations, such as PRB allocations, caused by the use of FDSS by limiting the filter attenuation by defining spectrum flatness requirements that are dependent on the resource allocation, like allocation size and allocation position in the BW configuration.

Moreover, total link budget may be maximized by taking into account receiver performance of BS 120. Also, transmit filter of UE 110 may be left for implementation of UE 110 also in future 3GPP releases, like Rel-17/18, which is good for the 3GPP ecosystem. Embodiments of the present invention may be applied for example in 3GPP TS 38.101 standard. In addition, at least some embodiments of the present invention provide support for spectral extended transmission by allowing for EVM equalizer spectrum flatness with more than two frequency bands.

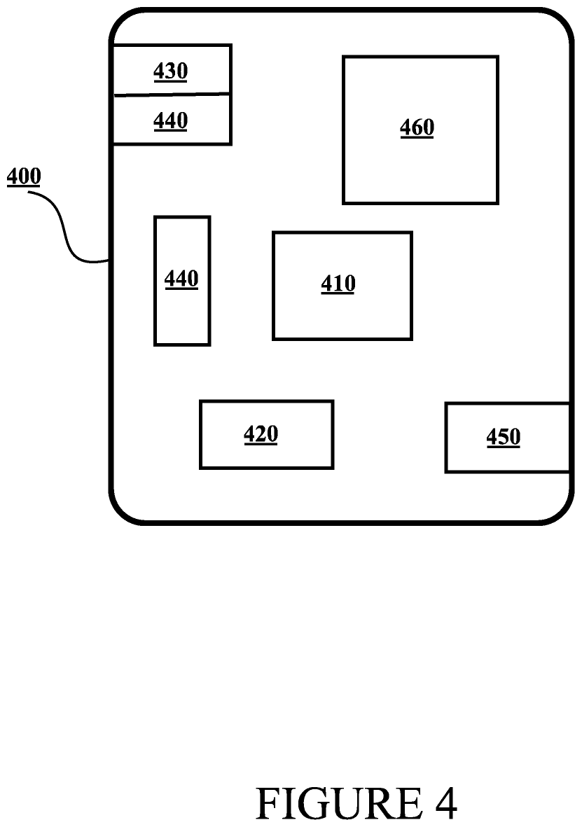

FIG. 4 illustrates an example apparatus capable of supporting at least some embodiments. Illustrated is device 400, which may be referred to as, for example, UE 110 or a control device configured to control UE 110. Comprised in device 400 is processor 410, which may comprise, for example, a single- or multi-core processor wherein a single-core processor comprises one processing core and a multi-core processor comprises more than one processing core. Processor 410 may comprise, in general, a control device. Processor 410 may comprise more than one processor. Processor 410 may be a control device. A processing core may comprise, for example, a Cortex-A8 processing core manufactured by ARM Holdings or a Steamroller processing core produced by Advanced Micro Devices Corporation. Processor 410 may comprise at least one Qualcomm Snapdragon and/or Intel Atom processor. Processor 410 may comprise at least one Application-Specific Integrated Circuit, ASIC. Processor 410 may comprise at least one Field-Programmable Gate Array, FPGA. Processor 410 may be means for performing method steps in device 400. Processor 410 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as UE 110, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 400 may comprise memory 420. Memory 420 may comprise random-access memory and/or permanent memory. Memory 420 may comprise at least one RAM chip. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part comprised in processor 410. Memory 420 may be at least in part external to device 400 but accessible to device 400.

Device 400 may comprise a transmitter 430. Device 400 may comprise a receiver 440. Transmitter 430 and receiver 440 may be configured to transmit and receive, respectively, information in accordance with at least one cellular or non-cellular standard. Transmitter 430 may comprise more than one transmitter. Receiver 440 may comprise more than one receiver. Transmitter 430 and/or receiver 440 may be configured to operate in accordance with Global System for Mobile Communication, GSM, Wideband Code Division Multiple Access, WCDMA, 5G/NR, Long Term Evolution, LTE, IS-95, Wireless Local Area Network, WLAN, Ethernet and/or Worldwide Interoperability for Microwave Access, WiMAX, standards, for example.

Device 400 may comprise a Near-Field Communication, NFC, transceiver 450. NFC transceiver 450 may support at least one NFC technology, such as NFC, Bluetooth, Wibree or similar technologies.

Device 400 may comprise User Interface, UI, 460. UI 460 may comprise at least one of a display, a keyboard, a touchscreen, a vibrator arranged to signal to a user by causing device 400 to vibrate, a speaker and a microphone. A user may be able to operate device 400 via UI 460, for example to accept incoming telephone calls, to originate telephone calls or video calls, to browse the Internet, to manage digital files stored in memory 420 or on a cloud accessible via transmitter 430 and receiver 440, or via NFC transceiver 450, and/or to play games.

Device 400 may comprise or be arranged to accept a user identity module 470. User identity module 470 may comprise, for example, a Subscriber Identity Module, SIM, card installable in device 400. A user identity module 470 may comprise information identifying a subscription of a user of device 400. A user identity module 470 may comprise cryptographic information usable to verify the identity of a user of device 400 and/or to facilitate encryption of communicated information and billing of the user of device 400 for communication effected via device 400.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. For example, where device 400 comprises a smartphone, it may comprise at least one digital camera. Some devices 400 may comprise a back-facing camera and a front-facing camera, wherein the back-facing camera may be intended for digital photography and the front-facing camera for video telephony. Device 400 may comprise a fingerprint sensor arranged to authenticate, at least in part, a user of device 400. In some embodiments, device 400 lacks at least one device described above. For example, some devices 400 may lack a NFC transceiver 450 and/or user identity module 470.

Processor 410, memory 420, transmitter 430, receiver 440, NFC transceiver 450, UI 460 and/or user identity module 470 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the embodiment various ways of interconnecting at least two of the aforementioned devices may be selected without departing from the scope of the present invention.

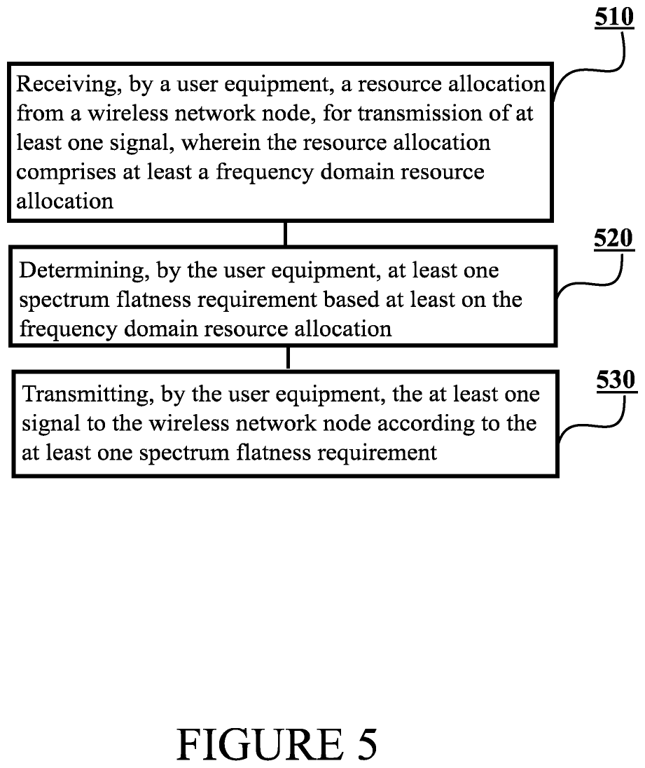

FIG. 5 is a flow graph of a first method in accordance with at least some example embodiments. The phases of the illustrated first method may be performed by UE 110 or by a control device configured to control the functioning thereof, possibly when installed therein.

The first method may comprise, at step 510, receiving, by a user equipment, a resource allocation from a wireless network node, for transmission of at least one signal, wherein the resource allocation comprises at least a frequency domain resource allocation. The first method may also comprise, at step 520, determining, by the user equipment, at least one spectrum flatness requirement based at least on the frequency domain resource allocation. Finally, the first method may comprise, at step 530, transmitting, by the user equipment, the at least one signal to the wireless network node according to the at least one spectrum flatness requirement.

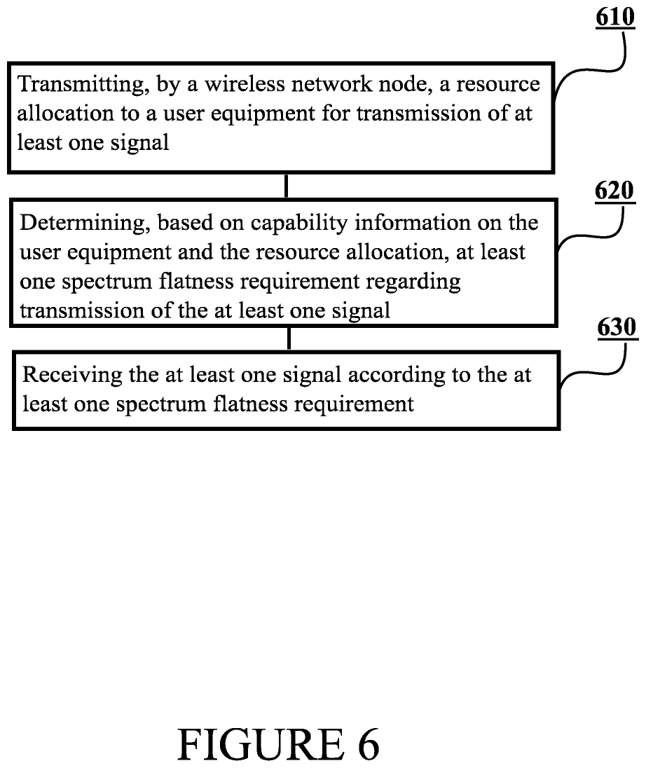

FIG. 6 is a flow graph of a second method in accordance with at least some example embodiments. The phases of the illustrated first method may be performed by a wireless network node, such as BS 120, or by a control device configured to control the functioning thereof, possibly when installed therein.

The second method may comprise, at step 610, transmitting, by a wireless network node, a resource allocation to a user equipment for transmission of at least one signal. The second method may also comprise, at step 620, determining, based on capability information on the user equipment and the resource allocation, at least one spectrum flatness requirement regarding transmission of the at least one signal. Finally, the second method may comprise, at step 630, receiving the at least one signal according to the at least one spectrum flatness requirement.

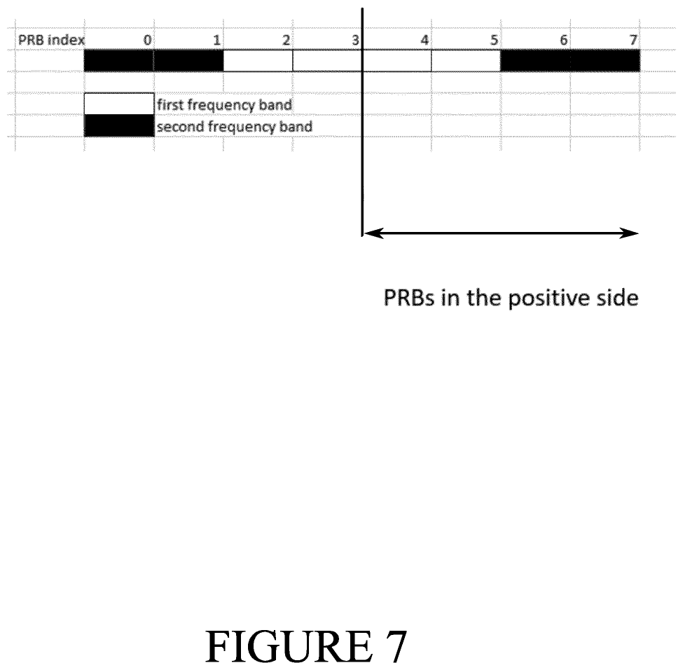

FIG. 7 illustrates a PUSCH with 8 PRBs in accordance with at least some embodiments.

In some embodiments, the current spectral flatness requirements may be kept for large PRB allocations (e.g. ≥16 PRBs). In some embodiments, tighter spectral flatness requirements may be considered for small PRB allocations (e.g. <16 PRBs) to optimize the net gain.

It is to be understood that the embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples may be referred to herein along with alternatives for the various components thereof. It is understood that such embodiments, examples, and alternatives are not to be construed as de facto equivalents of one another, but are to be considered as separate and autonomous representations.

In an exemplary embodiment, an apparatus, such as, for example, UE 110 or a control device configured to control UE 110, may comprise means for carrying out the embodiments described above and any combination thereof.

In an exemplary embodiment, a computer program may be configured to cause a method in accordance with the embodiments described above and any combination thereof. In an exemplary embodiment, a computer program product, embodied on a non-transitory computer readable medium, may be configured to control a processor to perform a process comprising the embodiments described above and any combination thereof.

In an exemplary embodiment, an apparatus, such as, for example, UE 110 or a control device configured to control UE 110, may comprise at least one processor, and at least one memory including computer program code, wherein the at least one memory and the computer program code are configured to, with the at least one processor, cause the apparatus at least to perform the embodiments described above and any combination thereof.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the embodiments in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in cellular communication networks, wherein it is desirable to perform spectral shaping with good performance.

### ACRONYMS LIST

3GPP 3rd Generation Partnership Project
ASIC Application-Specific Integrated Circuit
BPSK Binary PSK
BS Base Station
CM Cubic Metric
D2D Device-to-Device
DMRS Demodulation Reference Signal
EVM Error Vector Magnitude
FDRA Frequency Domain Resource Allocation
FDSS Frequency Domain Spectral Shaping
FPGA Field-Programmable Gate Array
GSM Global System for Mobile communication
IAB Integrated Access and Backhaul
IoT Internet of Things
LTE Long-Term Evolution
M2M Machine-to-Machine
MPR Maximum Power Reduction
NFC Near-Field Communication
NR New Radio
OBO Output Backoff
PAPR Peak-to-Average Power Ratio
PRB Physical Resource Block
PUSCH Physical Uplink Shared Channel
QAM Quadrature Amplitude Modulation
QPSK Quadrature PSK
RAN Radio Access Network
RAT Radio Access Technology
SIM Subscriber Identity Module
UE User Equipment
UI User Interface
WCDMA Wideband Code Division Multiple Access
WiMAX Worldwide Interoperability for Microwave Access
WLAN Wireless Local Area Network

REFERENCE SIGNS LIST

| | |
|---|---|
| 110 | User Equipment |
| 115, 125, 135 | Interfaces |
| 120 | Base Station |
| 130 | Core network |
| 202 | Transmission BW |
| 204 | Outermost PRBs (low) |
| 206 | Outermost PRBs (high) |
| 210 | Transmission BW configuration |
| 212 | Lower edge part |
| 214 | Higher edge part |
| 216 | Central part |
| 310-360 | Steps in FIG. 3 |
| 410-470 | Structure of the apparatus of FIG. 4 |
| 510-530 | Phases of the first method in FIG. 5 |
| 610-630 | Phases of the second method in FIG. 6 |

1. A method, comprising:
receiving, by a user equipment, a resource allocation from a wireless network node, for transmission of at least one signal, wherein the resource allocation comprises at least a frequency domain resource allocation;
determining, by the user equipment, at least one spectrum flatness requirement based at least on the frequency domain resource allocation; and
transmitting, by the user equipment, the at least one signal to the wireless network node according to the at least one spectrum flatness requirement.

2. A method according to claim 1, further comprising:
determining, by the user equipment, the at least one spectrum flatness requirement based at least on a size of the frequency domain resource allocation.

3. A method according to claim 2, wherein the size of the frequency domain resource allocation is a number of physical resource blocks.

4. A method according to claim 1, further comprising:
determining, by the user equipment, the at least one spectrum flatness requirement based at least on a location of the frequency domain resource allocation in frequency within a channel bandwidth and/or transmission bandwidth.

5. A method according to claim 4, wherein said determining the at least one spectrum flatness requirement based at least on the location of the frequency domain resource allocation comprises determining whether the frequency domain resource allocation is on a central part or an edge part of the channel bandwidth and/or transmission bandwidth.

6. A method according to claim 1, wherein the at least one spectrum flatness requirement comprises a maximum allowed ripple.

7. A method according to claim 6, wherein the maximum allowed ripple is smaller for frequency domain allocations below a threshold and larger for frequency domain allocations above the threshold.

8. A method according to claim 6, wherein the maximum allowed ripple is smaller for center allocations compared to edge allocations.

9. A method according to claim 6, wherein the maximum allowed ripple is calculated as follows:
$${R}_{n} = {k}_{n} * N + {C}_{n} ,$$
wherein Rₙ is the maximum allowed ripple, kₙ is a constant for a frequency band, N is a number of allocated physical resource blocks and Cₙ is another constant for the frequency band.

10. A method according to claim 6, wherein the maximum allowed ripple is defined separately for edge resource allocations, outer resource allocations and inner resource allocations.

11. A method according to claim 1, further comprising:
transmitting, by the user equipment, capability information on the user equipment to the wireless network node, wherein said capability information comprises an indication indicating that the user equipment supports frequency domain resource allocation-based spectrum flatness requirements.

12. A method according to claim 11, wherein the indication indicates that the user equipment supports frequency domain resource allocation-based spectrum flatness requirements for at least one modulation scheme.

13. A method according to claim 12, wherein the at least one modulation scheme comprises π/2 binary phase shift keying.

14. A method according to claim 1, further comprising:
receiving, by the user equipment, a configuration signal from the wireless network node, the configuration signal configuring the user equipment to switch adaptive spectrum flatness configuration on; and
switching, by the user equipment, the adaptive spectrum flatness configuration on to transmit the at least one signal according to the at least one spectrum flatness requirement.

15. A method according to claim 1, further comprising:
determining, by the user equipment, a transmit filter for transmitting the at least one signal according to the at least one adaptive spectrum flatness requirement; and
transmitting, by the user equipment, the at least one signal using the transmit filter.

16. A method according to claim 1, further comprising:
determining whether the at least one spectrum flatness requirement applies to one or more than one frequency band of the resource allocation.

17. A method according to claim 1, further comprising:
determining a frequency band of the resource allocation from at least two frequency bands; and
determining the at least one spectrum flatness requirement based on the determined frequency band.

18. (canceled)

19. A method, comprising:
transmitting, by a wireless network node, a resource allocation to a user equipment for transmission of at least one signal;
determining, based on capability information on the user equipment and the resource allocation, at least one spectrum flatness requirement regarding transmission of the at least one signal; and
receiving the at least one signal according to the at least one spectrum flatness requirement.

20-21. (canceled)

22. An apparatus comprising at least one processing core, at least one memory including computer program code, the at least one memory and the computer program code being configured to, with the at least one processing core, cause the apparatus at least to perform:
receive a resource allocation from a wireless network node, for transmission of at least one signal, wherein the resource allocation comprises at least a frequency domain resource allocation;
determine at least one spectrum flatness requirement based at least on the frequency domain resource allocation; and
transmit the at least one signal to the wireless network node according to the at least one spectrum flatness requirement.

23. (canceled)

24. An apparatus comprising at least one processing core, at least one memory including computer program code, the at least one memory and the computer program code being configured to, with the at least one processing core, cause the apparatus at least to perform:
transmit a resource allocation to a user equipment for transmission of at least one signal;
determine, based on capability information on the user equipment and the resource allocation, at least one spectrum flatness requirement regarding transmission of the at least one signal; and
receive the at least one signal according to the at least one spectrum flatness requirement.

25-31. (canceled)
